(19) United States
(12) Patent Application Publication
(10) Pub. No.: US 2023/0357552 A1
(43) Pub. Date: Nov. 9, 2023

(54) POLYMER COMPOSITION THAT IS RESISTANT TO OXIDATIVE DECOMPOSITION AND ARTICLE MADE THEREFROM

(71) Applicants: Zhiru MA, Columbia, MD (US); W. R. Grace & Co.-Conn., Columbia, MD (US)

(72) Inventor: Zhiru MA, Columbia, MD (US)

(73) Assignee: W. R. Grace & Co.-Conn., Columbia, MD (US)

(21) Appl. No.: 18/024,487

(22) PCT Filed: Aug. 31, 2021
(86) PCT No.: PCT/US2021/048425

§ 371 Date: Mar. 2, 2023

Related U.S. Application Data
(60) Provisional application No. 63/074,017, filed on Sep. 3, 2020.

(51) Int. Cl. C08L 23/32; C08K 5/52; C08K 5/12; C08K 5/13

(52) U.S. Cl. CPC C08L 23/32; C08K 5/12; C08K 5/13; C08K 5/52; C08L 2203/18; C08L 2205/242; C08L 2314/02

(57) ABSTRACT

Polymer compositions are disclosed that can be used to produce different types of molded articles, such as extruded piping structures. The polymer composition contains an oxidative stabilizing package. The oxidative stabilizing package contains at least one antioxidant, a nucleating agent, and an acid scavenger. The nucleating agent is a phosphate ester or a dicarboxylate metal salt. The stabilizing package of the present disclosure dramatically improves oxidation induction time.

### RELATED APPLICATIONS

The present application is based on, and claims priority to, U.S. Provisional Pat. Application Serial No. 63/074,017 filed Sep. 3, 2020, which is incorporated herein by reference.

### BACKGROUND

Polymer materials are frequently used for pipes for various purposes, such as fluid transport, i.e. transport of liquid or gas, e.g. water or natural gas, during which the fluid can be pressurized. Moreover, the transported fluid may have varying temperatures, usually within the temperature range of from about 0° C. to about 90° C.

Consequently, polymer materials used to construct pipes should have a particular blend of physical properties to prevent failure. For instance, the polymers used to form pipes should be capable of withstanding relatively high fluid pressures. In addition, the polymer material used to form the pipe must be able to withstand any additional strain associated with higher temperatures while also being impact resistant at lower temperatures.

The polymer used to produce the pipe should also be resistant to oxidative decomposition. Polymer pipes, for instance, should not degrade and fail when exposed to oxygen, even after long term use. In fact, pipe manufactures are now requiring that polymers used to construct the pipes have an extended oxidation induction time. The oxidation induction time is a relative measure of the resistance of the polymer material to oxidative decomposition, determined by a calorimetric measurement of the time interval to the onset of exothermic oxidation of the material at a specified temperature in an oxygen atmosphere, under atmospheric pressure.

In the past, pipes as described above have been made from polyolefin polymers, such as polypropylene polymers and polyethylene polymers. Problems have been experienced, however, in formulating polymer compositions not only capable of withstanding the conditions to which the pipes are exposed but also having sufficient oxidative resistance. The present disclosure is generally directed to polymer compositions well suited for producing pipes that have increased oxidative resistance.

### SUMMARY

In general, the present disclosure is directed to polymer composition particularly well suited for producing pipe structures. The pipe structures can be used in all different applications, including hot and cold-water pipe applications. The polymer composition of the present disclosure is formulated not only to withstand pipe pressures and temperatures, but has also been formulated to be oxidative resistant.

In one embodiment, the present disclosure is directed to a polymer composition well suited to forming piping structures. The polymer composition comprises a thermoplastic polymer, such as a polypropylene polymer, combined with an oxidative stabilizer package. The oxidative stabilizer package comprises at least one sterically hindered phenolic antioxidant, a phosphite antioxidant, an acid scavenger, and a nucleating agent. The nucleating agent can comprise a phosphate ester, a dicarboxylate metal salt, or mixtures thereof. The polymer composition is formulated with the oxidative stabilizer package such that the polymer composition displays an oxidation induction time when tested according to ISO Test 11357-6 (2018) at 210° C. of greater than 40 minutes, such as greater than about 42 minutes, such as greater than about 44 minutes, such as greater than about 46 minutes. The oxidation induction time is generally less than about 150 minutes.

In one aspect, the nucleating agent can be a metal salt of hexahydrophthalic acid, such as calcium hexahydrophthalic acid. In another aspect, the nucleating agent can be a bicyclic dicarboxylate metal salt. For instance, the nucleating agent can be disodium bicyclo[2.2. 1 ]heptane-2,3-dicarboxylate.

In another aspect, the nucleating agent can be the phosphate ester. The phosphate ester, for instance, can have the following chemical structure:

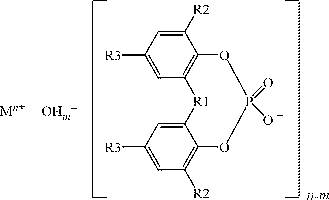

wherein R1 is oxygen, sulfur or a hydrocarbon group of 1 to 10 carbon atoms; each of R2 and R3 is hydrogen or a hydrocarbon or a hydrocarbon group of 1 to 10 carbon atoms; R2 and R3may be the same or different from each other; two of R2, two of R3, or R2 and R3 may be bonded together to form a ring; M is a monovalent to trivalent metal atom; n is an integer from 1 to 3; and m is either 0 or 1, provided that n>m.

In one aspect, for instance, the nucleating agent is 2,2′-methylene-bis-(4,6-di-tert-butylphenyl) phosphate.

In still another aspect, the polymer composition contains a blend of nucleating agents. For instance, the polymer composition can contain a dicarboxylate metal salt combined with a phosphate ester.

Each nucleating agent present in the polymer composition can be contained in the composition in an amount from about 150 ppm to about 1500 ppm. For instance, each nucleating agent can be present in the polymer composition in an amount from about 300 ppm to about 1100 ppm.

In one aspect, the polymer composition contains a mixture of sterically hindered phenolic antioxidants. For instance, the polymer composition can contain a first sterically hindered phenolic antioxidant comprising pentaerythrityl tetrakis (3,5-di-tert-butyl-4-hydroxyphenyl) propionate. The second sterically hindered phenolic antioxidant, on the other hand, can be a benzyl compound. The benzyl compound, for instance, can comprise 1,3,5-tri-(3,5-di-tert-butyl-4-hydroxybenzyl)-2,4,6-trimethylbenzene.

Each sterically hindered phenolic antioxidant contained in the polymer composition can generally be present in an amount of from about 500 ppm to about 9000 ppm. For example, each sterically hindered phenolic antioxidant can be present in the polymer composition in an amount of from about 1000 ppm to about 5000 ppm.

The phosphite antioxidant can generally be present in the polymer composition in an amount of from about 250 ppm to about 5000 ppm. For instance, the phosphite antioxidant can be present in the polymer composition in an amount from about 700 ppm to about 3600 ppm. In one aspect, the phosphite antioxidant can comprise tris(2,4,di-tert-butylphenyl) phosphite.

The acid scavenger present in the polymer composition can be a metal salt of a fatty acid or a hydrotalcite. In one aspect, the acid scavenger is a metal stearate, such as calcium stearate. Each acid scavenger can be present in the polymer composition generally in an amount from about 100 ppm to about 2000 ppm, such as from about 200 ppm to about 1500 ppm.

As described above, the thermoplastic polymer present in the polymer composition can be a polypropylene polymer. The polypropylene polymer can be present in the polymer composition in an amount greater than about 50% by weight, such as in an amount greater than about 60% by weight, such as in an amount greater than about 70% by weight, such as in an amount greater than about 80% by weight, such as in an amount greater than about 90% by weight, such as in an amount greater than about 95% by weight, such as in an amount greater than about 97% by weight. The polypropylene polymer can have a relatively low melt flow rate. For example, the polypropylene polymer can have a melt flow rate of from about 0.01 g/10 min to about 3 g/10 min, such as from about 0.1 g/10 min to about 2 g/10 min.

In one aspect, the polypropylene polymer can be a polypropylene homopolymer. Alternatively, the polypropylene polymer can be a polypropylene copolymer. In one aspect, for instance, the polypropylene polymer is a polypropylene random copolymer that can include ethylene in an amount from about 1% to about 5% by weight as a comonomer.

In one aspect, the thermoplastic polymer, such as the polypropylene polymer, can be Ziegler-Natta catalyzed. In one aspect, the polymer can be catalyzed in the presence of an internal electron donor that comprises a substituted phenylene diester.

The present disclosure is also directed to piping structures and/or piping components made from the polymer composition described above. In one embodiment, for instance, a piping component can include a tubular structure having a length. The tubular structure can define a hollow interior passageway surrounded by a wall. The wall can be made from a polymer composition as described above containing a thermoplastic polymer combined with an oxidative stabilizer package particularly well suited to protecting the polymer composition from oxidative degradation.

Other features and aspects of the present disclosure are discussed in greater detail below.

### BRIEF DESCRIPTION OF THE DRAWINGS

FIG. 1 represents one embodiment of a piping structure made in accordance with the present disclosure.

A full and enabling disclosure of the present invention, including the best mode thereof to one skilled in the art, is set forth more particularly in the remainder of the specification, which includes reference to the accompanying figure.

### DEFINITIONS AND TESTING PROCEDURES

The term “propylene-ethylene copolymer”, as used herein, is a copolymer containing a majority weight percent propylene monomer with ethylene monomer as a secondary constituent. A “propylene-ethylene copolymer” (also sometimes referred to as a polypropylene random copolymer, PPR, PP-R, RCP or RACO) is a polymer having individual repeating units of the ethylene monomer present in a random or statistical distribution in the polymer chain.

Melt flow rate (MFR), as used herein, is measured in accordance with the ASTM D 1238 test method at 230° C. with a 2.16 kg weight for propylene-based polymers.

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-98 using a 60 minute precipitation time and is also referred to herein as the “wet method”.

The XS “wet method” consists of weighing 2 g of sample and dissolving the sample in 200 ml o-xylene in a 400 ml flask with 24/40 joint. The flask is connected to a water-cooled condenser and the contents are stirred and heated to reflux under nitrogen (N₂), and then maintained at reflux for an additional 30 minutes. The solution is then cooled in a temperature controlled water bath at 25° C. for 60 minutes to allow the crystallization of the xylene insoluble (XI) fraction. Once the solution is cooled and the insoluble fraction precipitates from the solution, the separation of the XS portion from the XI portion is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)-[(m₃-m₂)*2/m1]*100, where m₁ is the original weight of the sample used, m₂ is the weight of empty aluminum pan, and m₃ is the weight of the pan and residue (the asterisk, *, here and elsewhere in the disclosure indicates that the identified terms or values are multiplied).

The sequence distribution of monomers in the polymer may be determined by ¹³C-NMR, which can also locate ethylene residues in relation to the neighboring propylene residues. ¹³C NMR can be used to measure ethylene content, Koenig B-value, triad distribution, and triad tacticity, and is performed as follows.

The samples are prepared by adding approximately 2.7 g of a 50/50 mixture of tetrachloroethane-d2/orthodichlorobenzene containing 0.025 M Cr(AcAc)3 to 0.20 g sample in a Norell 1001-7 10 mm NMR tube. The samples are dissolved and homogenized by heating the tube and its contents to 150° C. using a heating block. Each sample is visually inspected to ensure homogeneity.

The data are collected using a Bruker 400 MHz spectrometer equipped with a Bruker Dual DUL high-temperature CryoProbe. The data are acquired using 512 transients per data file, a 6 sec pulse repetition delay, 90 degree flip angles, and inverse gated decoupling with a sample temperature of 120° C. All measurements are made on non-spinning samples in locked mode. Samples are allowed to thermally equilibrate for 10 minutes prior to data acquisition. Percent mm tacticity and weight % ethylene are calculated according to methods commonly used in the art, which is briefly summarized as follows.

With respect to measuring the chemical shifts of the resonances, the methyl group of the third unit in a sequence of 5 contiguous propylene units consisting of head-to-tail bonds and having the same relative chirality is set to 21.83 ppm. The chemical shift of other carbon resonances are determined by using the above-mentioned value as a reference. The spectrum relating to the methyl carbon region (17.0-23 ppm) can be classified into the first region (21.1-21.9 ppm), the second region (20.4-21.0 ppm), the third region (19.5-20.4 ppm) and the fourth region (17.0-17.5 ppm). Each peak in the spectrum is assigned with reference to a literature source such as the articles in, for example, Polymer, T. Tsutsui et al., Vol. 30, Issue 7, (1989) 1350-1356 and/or Macromolecules, H. N. Cheng, 17 (1984) 1950-1955, the contents of which are incorporated herein by reference.

In the first region, the signal of the center methyl group in a PPP (mm) triad is located. In the second region, the signal of the center methyl group in a PPP (mr) triad and the methyl group of a propylene unit whose adjacent units are a propylene unit and an ethylene unit resonates (PPE-methyl group). In the third region, the signal of the center methyl group in a PPP (rr) triad and the methyl group of a propylene unit whose adjacent units are ethylene units resonate (EPE-methyl group).

PPP (mm), PPP (mr) and PPP (rr) have the following three-propylene units-chain structure with head-to-tail bonds, respectively. This is shown in the Fischer projection diagrams below.

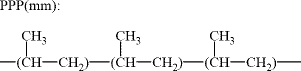

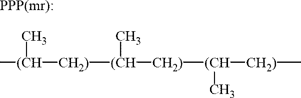

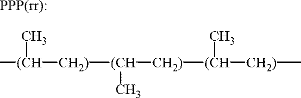

The triad tacticity (mm fraction) of the propylene random copolymer can be determined from a ¹³C-NMR spectrum of the propylene random copolymer using the following formula:

$$m m \text{Fraction} = \frac{P P P \left(m m\right)}{P P P \left(m m\right) + P P P \left(m r\right) + P P P \left(r r\right)}$$

The peak areas used in the above calculation are not measured directly from the triad regions in the ¹³C-NMR spectrum. The intensities of the mr and rr triad regions need to have subtracted from them the areas due to EPP and EPE sequencing, respectively. The EPP area can be determined from the signal at 30.8 ppm after subtracting from it one-half the area of the sum of the signals between 26 and 27.2 ppm and the signal at 30.1 ppm. The area due to EPE can be determined from the signal at 33.2 ppm.

For convenience, ethylene content is also measured using a Fourier Transform Infrared method (FTIR) which is correlated to ethylene values determined using ¹³C NMR, noted above, as the primary method. The relationship and agreement between measurements conducted using the two methods is described in, e.g., J. R. Paxson, J. C. Randall, “Quantitative Measurement of Ethylene Incorporation into Propylene Copolymers by Carbon-13 Nuclear Magnetic Resonance and Infrared Spectroscopy”, Analytical Chemistry, Vol. 50, No. 13, November 1978, 1777-1780.

Mw/Mn (also referred to as “MWD”) and Mz/Mw are measured by GPC according to the Gel Permeation Chromatography (GPC) Analytical Method for Polypropylene. The polymers are analyzed on a PL-220 series high temperature gel permeation chromatography (GPC) unit equipped with a refractometer detector and four PLgel Mixed A (20 µm) columns (Polymer Laboratory Inc.). The oven temperature is set at 150° C. and the temperatures of autosampler’s hot and the warm zones are at 135° C. and 130° C. respectively. The solvent is nitrogen purged 1,2,4-trichlorobenzene (TCB) containing ^{~}200 ppm 2,6-di-t-butyl-4-methylphenol (BHT). The flow rate is 1.0 mL/min and the injection volume was 200 µl. A 2 mg/mL, sample concentration is prepared by dissolving the sample in N2 purged and preheated TCB (containing 200 ppm BHT) for 2.5 hrs at 160° C. with gentle agitation.

The GPC column set is calibrated by running twenty narrow molecular weight distribution polystyrene standards. The molecular weight (MW) of the standards ranges from 580 to 8,400,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 150° C. for 30 min under stirring. The narrow standards mixtures are run first and in order of decreasing highest molecular weight component to minimize degradation effect. A logarithmic molecular weight calibration is generated using a fourth-order polynomial fit as a function of elution volume. The equivalent polypropylene molecular weights are calculated by using following equation with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene(E. P. Otocka, R. J. Roe, N. Y. Hellman, P. M. Muglia, Macromolecules, 4, 507 (1971)):

$${M}_{p p} = {\left(\frac{{K}_{r s} {M}_{p s}^{{}^{D} p s + 1}}{{K}_{p p}}\right)}^{\frac{1}{p p + 1}}$$

where Mₚₚ is PP equivalent MW, M_{PS} is PS equivalent MW, log K and a values of Mark-Houwink coefficients for PP and PS are listed below in Table 1.

TABLE 1

| Polymer | A | Log K |
|---|---|---|
| Polypropylene | 0.725 | -3.721 |
| Polystyrene | 0.702 | -3.900 |

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition containing a thermoplastic polymer and having improved oxidative resistance. In particular, a thermoplastic polymer is combined with a stabilizer package. The stabilizer package dramatically improves the ability of the polymer composition to resist oxidative decomposition. In accordance with the present disclosure, the stabilizer package generally contains at least one antioxidant, an acid scavenger, and a nucleating agent. Particular different types of nucleating agents are used that have been found to dramatically improve oxidative resistance.

Oxidative resistance can be measured according to ISO Test No. 11357-6 (2018). The ISO Test measures oxidation induction time. During the test, a specimen and a reference material are heated at a constant rate in an inert gaseous environment. When a specified temperature has been reached, the atmosphere is changed to contain oxygen. Oxygen contacts the specimen at a constant flow rate. The specimen is then held at constant temperature until an oxidative reaction is displayed on a thermal curve. The isothermal oxidation induction time is the time interval between the initiation of oxygen flow and the onset of the oxidative reaction. The onset of oxidation is indicated by an abrupt increase in the specimen’s evolved heat. This evolved heat can be observed using differential scanning calorimeter (DSC).

The stabilizer package of the present disclosure is capable of increasing the oxidation induction time of a thermoplastic polymer by greater than about 7%, such as greater than about 9%, such as greater than about 11%, such as greater than about 13%, such as greater than about 15%.

In one embodiment, the thermoplastic polymer contained in the polymer composition is a polypropylene polymer. In general, any suitable polypropylene polymer can be combined with a stabilizer package in accordance with the present disclosure. The polypropylene polymer, for instance, can be a polypropylene homopolymer, a polypropylene copolymer, or a polypropylene terpolymer. Polypropylene copolymers that can be used in accordance with the present disclosure include polypropylene random copolymers that contain ethylene as a comonomer or butylene as a comonomer. The polypropylene polymer can also be a heterophasic polymer containing a polypropylene homopolymer or copolymer combined with a polypropylene copolymer that has elastomeric properties.

In addition to polypropylene polymers, various other thermoplastic polymers may be present in the polymer composition. For instance, the thermoplastic polymer can be a polyethylene polymer. The polyethylene polymer can be a polyethylene homopolymer or a polyethylene copolymer. Other polymers that may be included in the polymer composition are polyester polymers such as polybutylene terephthalate.

Other various different molded articles can be made according to the present disclosure, in one embodiment, the polymer composition of the present disclosure is used to produce pipe structures. The pipe structures can be used in both cold and hot water pipe applications. Pipe structures made according to the present disclosure not only have improved resistance to oxidation, but are also capable of withstanding high pressures even during temperature swings. Polymer compositions can be formulated in accordance with the present disclosure with excellent impact resistance, toughness, and strength.

As described above, the stabilizer package of the present disclosure generally contains one or more nucleating agents combined with at least one antioxidant and an acid scavenger. The nucleating agent is selected from a particular class of compounds. It has been found to synergistically work with the other components to dramatically increase oxidative resistance.

In general, the nucleating agent can be a dicarboxylate metal salt, a phosphate ester, or mixtures thereof.

For example, in one embodiment, the nucleating agent is a cycloaliphatic metal salt, such as a dicarboxylate metal salt. For example, the nucleating agent comprises specific metal salts of hexahydrophthalic acid (and will be referred to herein as HHPA). In this embodiment, the nucleating agent conforms to the structure of the following formula:

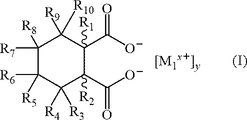

R₁, R₂, R₃, R₄, R₅, R₆, R₇, R₈, R₉, and R₁₀ are either the same or different and are individually selected from the group consisting of hydrogen, C₁-C₉ alkyl, hydroxy, C₁-C₉ alkoxy, C₁-C₉ alkyleneoxy, amine, and C₁-C₉ alkylamine, halogens, and phenyl. M₁ is a metal or organic cation, x is an integer from 1 to 2, and y is an integer from 1 to 2. Preferably, M₁ is selected from the group of calcium, strontium, lithium, and monobasic aluminum.

In one embodiment, M₁ is a calcium cation and R1-R10 are hydrogen. Ca HHPA as referred to herein can have the formula below. One may employ HYPERFORM™ HPN-20E from Milliken & Company of Spartanburg, S.C. which is commercially sold, and comprises Ca HHPA and is described for example in U.S. Pat. No. 6,599,971 which is hereby incorporated by reference in its entirety.

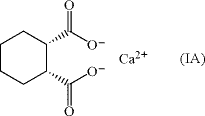

In another embodiment, the nucleating agent is a bicyclic dicarboxylate metal salt described, for example, in U.S. Pat. Nos. 6,465,551 and 6,534,574. The nucleating agent conforms to the structure of the following formula:

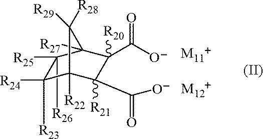

where M₁₁ and M₁₂, are the same or different, or M₁₁ and M₁₂ are combined to form a single moiety and are independently selected from the group consisting of metal or organic cations. Preferably M₁₁ and M₁₂ (or the single moiety from the combined M₁₁ and M₁₂) are selected from the group consisting of sodium, calcium, strontium, lithium, zinc, magnesium, and monobasic aluminum. Wherein R₂₀, R₂₁, R₂₂, R₂₃, R₂₄, R₂₅, R₂₆, R₂₇, R₂₈, and R₂₉ are independently selected from the group consisting of hydrogen and C₁-C₉ alkyls; and further wherein any two adjacently positioned R₂₂-R₂₉ alkyl groups optionally may be combined to form a carbocyclic ring. Preferably, R₂₂-R₂₉ are hydrogen and M₁₁ and M₁₂ are a sodium cations.

In particular, suitable bicyclic dicarboxylate metal salts include disodium bicyclo[2.2.1]heptane-2,3-dicarboxylate, calcium bicyclo[2.2.1]heptane-2,3-dicarboxylate, and combinations thereof. One may employ HYPERFORM™ HPN-68 or HPN-68L from Milliken & Company of Spartanburg, S.C. HPN-68L is commercially sold, and comprises the disodium bicyclo[2.2.1]heptane-2,3-dicarboxylate shown in the following formula.

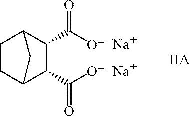 [SMILES: O=C([O-])[C@@H]1C2CCC(C2)[C@@H]1C(=O)[O-] ; [Na+] ; [Na+]]

In another embodiment, the nucleating agent is a phosphate ester salt. For example, the nucleating agent may be selected from the group of phosphorous based nucleating agents like phosphoric acid esters metal salts represented by the following structure.

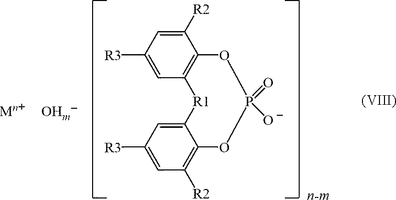

wherein R1 is oxygen, sulfur or a hydrocarbon group of 1 to 10 carbon atoms; each of R2 and R3 is hydrogen or a hydrocarbon or a hydrocarbon group of 1 to 10 carbon atoms; R2 and R3 may be the same or different from each other; two of R2, two of R3, or R2 and R3 may be bonded together to form a ring; M is a monovalent to trivalent metal atom; n is an integer from 1 to 3; and m is either 0 or 1, provided that n>m.

Examples of alpha nucleating agents represented by the above formula include sodium-2,2′-methylene-bis(4,6-di-t-butyl-phenyl)phosphate, sodium-2,2′-ethylidene-bis(4,6-di-t-butylphenyl)-phosphate, lithium-2,2′-methylene-bis(4,6-di-t-butylphenyl)phosphate, lithium-2,2′-ethylidene-bis(4,6-di-t-butylphenyl)phosphate, sodium-2,2′-ethylidene-bis(4-i-propyl-6-t-butylphenyl)phosphate, lithium-2,2′-methylene-bis(4-methyl-6-t-butylphenyl)phosphate, lithium-2,2′-methylene-bis(4-ethyl-6-t-butylphenyl)phosphate, calcium-bis[2,2′-thiobis(4-methyl-6-t-butyl-phenyl)-phosphate], calcium-bis[2,2′-thiobis(4-ethyl-6-t-butylphenyl)-phosphate], calcium-bis[2,2′-thiobis(4,6-di-t-butylphenyl)phosphate], magnesium-bis[2,2′-thiobis(4,6-di-t-butylphenyl)phosphate], magnesium-bis[2,2′-thiobis(4-t-octylphenyl)phosphate], sodium-2,2′-butylidene-bis(4,6-dimethylphenyl)phosphate, sodium-2,2′-butylidene-bis(4,6-di-t-butyl-phenyl)-phosphate, sodium-2,2′-t-octylmethylene-bis(4,6-dimethyl-phenyl)-phosphate, sodium-2,2′-t-octylmethylene-bis(4,6-di-t-butylphenyl)-phosphate, calcium-bis[2,2′-methylene-bis(4,6-di-t-butylphenyl)-phosphate], magnesium-bis[2,2′-methylene-bis(4,6-di-t-butylphenyl)-phosphate], barium-bis[2,2′-methylene-bis(4,6-di-t-butylphenyl)-phosphate], sodium-2,2′-methylene-bis(4-methyl-6-t-butylphenyl)-phosphate, sodium-2,2′-methylene-bis(4-ethyl-6-t-butylphenyl)phosphate, sodium(4,4′-dimethyl-5,6′-dit-butyl-2,2′-biphenyl)phosphate, calcium-bis-[(4,4′-dimethyl-6,6′-di-t-butyl-2,2′-biphenyl)phosphate], sodium-2,2′-ethyli-dene-bis(4-m-butyl-6-t-butyl-phenyl)phosphate, sodium-2,2′-methylene-bis-(4,6-di-methylphenyl)-phosphate, sodium-2,2′-methylene-bis(4,6-di-t-ethyl-phenyl)phosphate, potassium-2,2′-ethylidene-bis(4,6-di-t-butylphenyl)-phosphate, calcium-bis[2,2′-ethylidene-bis(4,6-di-t-butylphenyl)-phosphate], magnesium-bis[2,2′-ethylidene-bis(4,6-di-t-butylphenyl)-phosphate], barium-bis[2,2′-ethylidene-bis-(4,6-di-t-butylphenyl)-phosphate], aluminium-hydroxy-bis[2,2′-methylene-bis(4,6-di-t-butylphenyl)phosphate], aluminium-tris[2,2′-ethylidene-bis(4,6-di-t-butylphenyl)-phosphate].

A second group of phosphorous based nucleating agents includes for example aluminium-hydroxy-bis[2,4,8,10-tetrakis(1,1-dimethylethyl)-6-hydroxy-12H-dibenzo-[d,g]-dioxa-phoshocin-6-oxidato] and blends thereof with Li-myristate or Li-stearate

In one embodiment, the stabilizing package can include a combination of a phosphate ester and a dicarboxylate metal salt. Alternatively, the stabilizer package can include a mixture of two or more phosphate esters or a mixture of two or more dicarboxylate metal salts.

Each nucleating agent can be present in the polymer composition generally in an amount from about 150 ppm to 1500 ppm, including all increments of 50 ppm there between. For example, each nucleating agent can be present in the polymer composition in an amount greater than about 200 ppm, such as in an amount greater than about 250 ppm, such as in an amount greater than 300 ppm, such as in an amount greater than about 350 ppm, such as in an amount greater than about 400 ppm, such as in an amount greater than about 450 ppm and generally in an amount less than about 1200 ppm, such as in an amount less than about 1000 ppm, such as in an amount less than about 800 ppm, such as in an amount less than about 600 ppm.

In addition to one or more nucleating agents, the stabilizer package further contains at least one antioxidant. For example, the stabilizer package can contain one or more sterically hindered phenolic antioxidants. Examples of sterically hindered phenolic antioxidants are as follows:

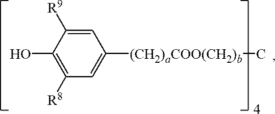

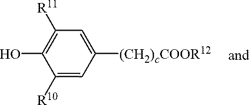

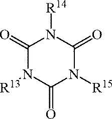

wherein,
a, b and c independently range from 1 to 10, and in some embodiments, from 2 to 6;
R⁸, R⁹, R¹⁰, R¹¹, and R¹² are independently selected from hydrogen, C₁ to C₁₀ alkyl, and C₃ to C₃₀ branched alkyl, such as methyl, ethyl, propyl, isopropyl, butyl, or tertiary butyl moieties; and
R¹³, R¹⁴ and R¹⁵ are independently selected from moieties represented by one of the following general structures:

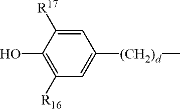

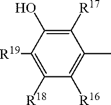

wherein,
   d ranges from 1 to 10, and in some embodiments, from 2 to 6;
   R¹⁶, R¹⁷, R¹⁸, and R¹⁹ are independently selected from hydrogen, C₁ to C₁₀ alkyl, and C₃ to C₃₀ branched alkyl, such as methyl, ethyl, propyl, isopropyl, butyl, or tertiary butyl moieties.
   Another example of a suitable antioxidant is as follows:

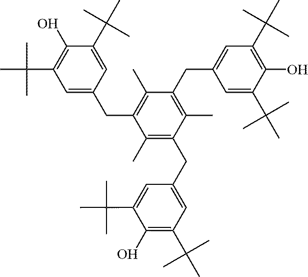 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1]

Specific examples of suitable hindered phenols having a general structure as set forth above may include, for instance, 2,6-di-tert-butyl-4-methylphenol; 2,4-di-tert-butylphenol; pentaerythrityl tetrakis(3,5-di-tert-butyl-4-hydroxyphenyl)propionate; octadecyl-3-(3’,5′-di-tert-butyl-4′-hydroxyphenyl)propionate; tetrakis[methylene(3,5-di-tert-butyl-4-hydroxycinnamate)]methane; bis-2,2′-methylene-bis(6-tert-butyl-4-methylphenol)terephthalate; 1,3,5-trimethyl-2,4,6-tris(3,5-di-tert-butyl-4-hydroxybenzyl)benzene; tris(3,5-di-tert-butyl-4-hydroxybenzyl)isocyanurate; 1,3,5-tris(4-tert-butyl-3-hydroxy-2,6-dimethylbenzyl)1,3,5-triazine-2,4,6-(1H,3H,5H)-trione; 1,1,3-tris(2-methyl-4-hydroxy-5-tert-butylphenyl)butane; 1,3,5-triazine-2,4,6(1H,3H,5H)-trione; 1,3,5-tris[[3,5-bis-(1,1-dimethylethyl)-4- hydroxyphenyl]methyl]; 4,4’,4″-[(2,4,6-trimethyl-1,3,5-benzenetriyl)tris-(methylene)]tris[2,6-bis(1,1-dimethylethyl)]; 6-tert-butyl-3-methylphenyl; 2,6-di-tert-butyl-p-cresol; 2,2′-methylenebis(4-ethyl-6-tert-butylphenol); 4,4′-butylidenebis(6-tert-butyl-m-cresol); 4,4′-thiobis(6-tert-butyl-m-cresol); 4,4′-dihydroxydiphenyl-cyclohexane; alkylated bisphenol; styrenated phenol; 2,6-di-tert-butyl-4-methylphenol; n-octadecyl-3-(3”,5′-di-tert-butyl-4′-hydroxyphenyl)propionate; 2,2′-methylenebis(4-methyl-6-tertbutylphenol); 4,4′-thiobis(3-methyl-6-tert-butylphenyl); 4,4′-butylidenebis(3-methyl-6-tertbutylphenol); stearyl-β-(3,5-di-tert-butyl-4-hydroxyphenyl)propionate; 1,1,3-tris(2-methyl-4-hydroxy-5-tert-butylphenyl)butane; 1,3,5-trimethyl-2,4,6-tris(3,5-di-tert-butyl-4-hydroxybenzyl)benzene; 1,3,5-trimethyl-2,4,6-tris (3,5-di-tert-butyl-4-hydroxybenzyl) benzene; tetrakis[methylene-3-(3′,5′-di-tert-butyl-4′-hydroxyphenyl)propionate]methane, stearyl 3,5-di-tert-butyl-4-hydroxyhydocinnamate; and so forth, as well as mixtures thereof.

In one aspect, the stabilizer package includes a combination of sterically hindered phenolic antioxidants. For example, the stabilizer package can include a first sterically hindered phenolic comprising pentaerythrityl tetrakis (3,5-di-tert-butyl-4-hydroxyphenyl) propionate combined with a second sterically hindered phenolic antioxidant comprising a benzyl compound. The benzyl compound can comprise 1,3,5-trimethyl-2,4,6-tris (3,5-di-tert-butyl-4-hydroxybenzyl) benzene or 1,3,5-tri-(3,5-di-tert-butyl-4-hydroxybenzyl)-2,4,6-trimethylbenzene.

Each sterically hindered phenolic antioxidant can be present in the polymer composition generally in an amount from about 500 ppm to about 9000 ppm, including all increments of 50 ppm there between. For example, each sterically hindered phenolic antioxidant can be present in the polymer composition in an amount greater than about 800 ppm, such as in an amount greater than about 1000 ppm, such as in an amount greater than about 1200 ppm, such as in an amount greater than about 1400 ppm, such as in an amount greater than about 1600 ppm, such as in an amount greater than about 1800 ppm, such as in an amount greater than about 2000 ppm, such as in an amount greater than about 2200 ppm, such as in an amount greater than about 2400 ppm, such as in an amount greater than about 2600 ppm, such as in an amount greater than about 2800 ppm. Each sterically hindered phenolic antioxidant can be present in the polymer composition generally in an amount less than about 8000 ppm, such as an amount less than about 7000 ppm, such as an amount less than about 5000 ppm. In addition to one or more sterically hindered phenolic antioxidants, the stabilizer package of the present disclosure may also contain a phosphite antioxidant.

The phosphite antioxidant may include a variety of different compounds, such as aryl monophosphites, aryl disphosphites, etc., as well as mixtures thereof. For example, an aryl diphosphite may be employed that has the following general structure:

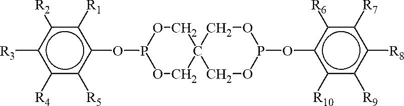

wherein, R₁, R₂, R₃, R₄, R₅, R₆, R₇, R₈, R₉, and R₁₀ are independently selected from hydrogen, C₁ to C₁₀ alkyl, and C₃ to C₃₀ branched alkyl, such as methyl, ethyl, propyl, isopropyl, butyl, or tertiary butyl moieties.

Examples of such aryl diphosphite compounds include, for instance, bis(2,4-dicumylphenyl)pentaerythritol diphosphite and bis(2,4-di-t-butylphenyl)pentaerythritol diphosphite. Likewise, suitable aryl monophosphites may include tris(2,4-di-tert-butylphenyl)phosphite; bis(2,4-di-tert-butyl-6-methylphenyl) ethyl phosphite; and so forth.

When present in the polymer composition, the phosphite antioxidant can be contained in the polymer composition generally in an amount to about 4500 ppm including all increments of 50 ppm therebetween. For example, the phosphite antioxidant can be present in the polymer composition generally in an amount greater than about 500 ppm, such as in an amount greater than abut 1000 ppm, such as in an amount greater than about 1500 ppm, such as in an amount greater than about 1700 ppm, and generally in an amount less than about 5000 ppm, such as in an amount less than about 4000 ppm, such as in an amount less than about 3500 ppm.

The stabilizer package of the present disclosure may also contain an acid scavenger. The acid scavenger, for instance, may comprise a metal salt of a fatty acid, a hydrotalcite, a talc, or mixtures thereof. In one embodiment, the acid scavenger is a metal stearate. In one aspect, the acid scavenger is calcium stearate.

In general, each acid scavenger present in the polymer composition can be included in an amount from about 50 ppm to about 2000 ppm, including all increments of 50 ppm therebetween. For example, each acid scavenger can be present in the polymer composition in an amount greater than about 70 ppm, such as in an amount greater than about 100 ppm, such as in an amount greater than about 150 ppm, such as in an amount greater than about 200 ppm, such as in an amount greater than about 250 ppm, such as in an amount greater than about 270 ppm. Each acid scavenger can be present in the polymer composition in an amount less than about 1200 ppm, such as in an amount less 800 ppm, such as in an amount less than about 600 ppm, such as in an amount less than about 400 ppm.

The components of the stabilizer package can be combined with the thermoplastic polymer individually or can first be mixed together and then combined with the thermoplastic polymer simultaneously. In one particular embodiment, the stabilizer package can be pre-compounded with a thermoplastic polymer and then later melt processed with the primary polymer present in the polymer composition. For example, in one embodiment, the stabilizer package can be pre-compounded with a polypropylene polymer to form a masterbatch. The masterbatch can then be combined with the same or a different polypropylene polymer in forming the polymer composition of the present disclosure.

In addition to the stabilizer package of the present disclosure, the polymer composition can contain various other additives. For instance, the polymer composition can contain mold release agents, slip agents, antiblocks, UV stabilizers, heat stabilizers, coloring agents, and the like. Each of the above additives can be present in the polymer composition generally in an amount less than about 3% by weight, such as in an amount less than about 2% by weight, such as in an amount less than about 1% by weight, and generally in an amount greater than about 0.01% by weight, such as in an amount greater than about 0.5% by weight.

When forming pipe structures, in one embodiment, the thermoplastic polymer is a polypropylene random copolymer. The polypropylene random copolymer generally contains propylene as a primary monomer combined with an alkylene comonomer. For instance, in one embodiment, the comonomer is ethylene. In one particular embodiment, the polypropylene random copolymer contains ethylene generally in an amount less than about 6% by weight, such as in an amount less than about 5% by weight, such as in an amount less than about 4.5% by weight, such as in an amount generally less than about 4% by weight, such as in an amount less than about 3.5% by weight, such as in an amount less than about 3% by weight. The ethylene content is generally greater than about 1%, such as greater than about 1.5%, such as greater than about 2%, such as greater than about 2.5%. In general, increasing the ethylene content of the copolymer can increase the impact resistance properties of the polymer composition. Increasing the ethylene content, however, can also cause a decrease in the flexural modulus.

The polypropylene random copolymer in addition to having a controlled ethylene content can also have a relatively low xylene soluble content. For instance, the polymer composition can have a total XS content or fraction of less than about 14% by weight, such as less than about 12% by weight, such as less than about 11% by weight, such as less than about 10% by weight, such as less than about 9% by weight, such as less than about 8% by weight, such as less than about 7% by weight, such as less than about 6% by weight, such as less than about 5% by weight. The XS content is generally greater than about 2% by weight.

The polypropylene copolymer can comprise a Ziegler-Natta catalyzed polymer and can have a relatively controlled molecular weight distribution. For instance, the molecular weight distribution (Mw/Mn) can be greater than about 5, such as greater than about 5.5, such as greater than about 6, such as greater than about 6.5, such as greater than about 7, such as greater than about 7.5, and generally less than about 10, such as less than about 9, such as less than about 8.

The polypropylene random copolymer incorporated into the polymer composition of the present disclosure can be produced using different polymerization methods and procedures. In one embodiment, a Ziegler-Natta catalyst is used to produce the polymer. For example, the olefin polymerization can occur in the presence of a catalyst system that includes a catalyst, an internal electron donor, a cocatalyst, and optionally an external electron donor. Olefins of the formula CH₂=CHR, where R is hydrogen or a hydrocarbon radical with 1 to 12 atoms, can be contacted with the catalyst system under suitable conditions to form the polymer products. Copolymerization may occur in a method-step process. The polymerization process can be carried out using known techniques in the gas phase using fluidized bed or stir bed reactors or in a slurry phase using an inert hydrocarbon solvent or diluent or liquid monomer.

The polypropylene random copolymer incorporated into the polymer composition can be a monomodal polymer or can comprise a heterophasic polymer composition. A monomodal random copolymer is generally produced in a single reactor. Monomodal random copolymers are single phased polymers with respect to molecular weight distribution, comonomer content, and melt flow index.

Heterophasic polymers, on the other hand, are typically produced using multiple reactors. In one embodiment, the first phase polymer and the second phase polymer can be produced in a two-stage process. In a first stage, a polypropylene polymer is produced that can be a homopolymer or a random copolymer that forms a continuous polymer phase in the final product. The first phase polymer is transferred to a second reactor to continue the polymerization process. The second phase polymer, formed in the second reactor, is an elastomeric polypropylene copolymer. The first stage polymerization can be carried out in one or more bulk reactors or in one or more gas phase reactors. The second stage polymerization can be carried out in one or more gas phase reactors. The second stage polymerization is typically carried out directly following the first stage polymerization. For example the polymerization product recovered from the first polymerization stage can be conveyed directly to the second polymerization stage. A heterophasic copolymer composition is produced.

In one embodiment of the present disclosure, the polymerizations are carried out in the presence of a stereoregular olefin polymerization catalyst. For example, the catalyst may be a Ziegler-Natta catalyst. For instance, in one embodiment, a catalyst sold under the trade name CONSISTA and commercially available from W. R. Grace & Company can be used. In one embodiment, electron donors are selected that do not contain phthalates.

In one embodiment, the catalyst includes a procatalyst composition that contains a titanium moiety such as titanium chloride, a magnesium moiety such as magnesium chloride, and at least one internal electron donor.

The procatalyst precursor can include (i) magnesium, (ii) a transition metal compound from Periodic Table groups IV-VII, (iii) a halide, an oxylahilde, and or an alkoxide, and/or an alkoxide of (i) or (i) and/or (ii), and (iv) combination of (i), (ii), and (iii). Non limiting examples of suitable procatalyst precursors include halides, oxyhalides, alkoxides of magnesium, manganese, titanium, vanadium, chromium, molybdenum, zirconium, hafnium, and combinations thereof.

In an embodiment, the procatalyst precursor contains magnesium as the sole metal component. Non limiting examples include anhydrous magnesium chloride and/or its alcohol adduct, magnesium alkoxide, and or aryloxide, mixed magnesium alkoxy halide, and/or carboxylated magnesium dialkoxide or aryloxide.

In an embodiment, the procatalyst precursor is an alcohol adduct of anhydrous magnesium chloride. The anhydrous magnesium chloride adduct is generally defined as MgCl₂-nROH where n has a range of 1.5-6.0, preferably 2.5-4.0, and most preferably 2.8-3.5 moles total alcohol. ROH is a C₁-C₄ alcohol, linear or branched, or mixture of alcohol. Preferably ROH is ethanol or a mixture of ethanol and a higher alcohol. If ROH is a mixture, the mole ratio of ethanol to higher alcohol is at least 80:20, preferably 90:10, and most preferably at least 95:5.

In one embodiment, a substantially spherical MgCl₂-nEtOH adduct may be formed by a spray crystallization process. In one, embodiment the spherical MgCl₂ precursor has an average particle size (Malvern d₅₀) of between about 15-150 microns, preferably between 20-100 microns, and most preferably between 35-85 microns.

In one embodiment, the procatalyst precursor contains a transition metal compound and a magnesium metal compound. The transition metal compound has the general formula TrXₓ where Tr is the transition metal, X is a halogen or a C₁₋₁₀ hydrocarboxyl or hydrocarbyl group, and x is the number of such X groups in the compound in combination with a magnesium metal compound. Tr may be a Group IV, V or VI metal. In one embodiment, Tr is a Group IV metal, such as titanium. X may be chloride, bromide, C₁₋₄ alkoxide or phenoxide, or a mixture thereof. In one embodiment, X is chloride.

The precursor composition may be prepared by the chlorination of the foregoing mixed magnesium compounds, titanium compounds, or mixtures thereof

In one embodiment, the precursor composition is a mixed magnesium/titanium compound of the formula Mg_{d}Ti(OR^{e})_{f}X_{g} wherein R^{e} is an aliphatic or aromatic hydrocarbon radical having 1 to 14 carbon atoms or COR’ wherein R′ is an aliphatic or aromatic hydrocarbon radical having 1 to 14 carbon atoms; each OR^{e} group is the same or different; X is independently chlorine, bromine or iodine; d is 0.5 to 56; or 2-4, or 3; f is 2 to 116, or 5 to 15; and g is 0.5 to 116, or 1 to 3.

In accordance with the present disclosure, the above described procatalyst precursor is combined with at least one internal electron donor. The internal electron donor can comprise a substituted phenylene aromatic diester.

In one embodiment, the first internal electron donor comprises a substituted phenylene aromatic diester having the following structure (I):

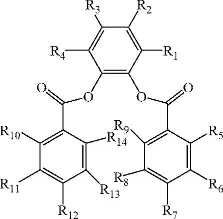

wherein R₁-R₁₄ are the same or different. Each of R₁-R₁₄ is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. At least one R₁-R₁₄ is not hydrogen.

In one embodiment, the substituted phenylene aromatic diester may be any substituted phenylene aromatic diester as disclosed in U.S. Pat. Application Serial No. 61/141,959 filed on Dec. 31, 2008, the entire content of which is incorporated by reference herein.

In one embodiment, the substituted phenylene aromatic diester may be any substituted phenylene aromatic diester disclosed in WO12088028, filed on Dec. 20, 2011, the entire content of which is incorporated by reference herein.

In one embodiment, at least one (or two, or three, or four) R group(s) of R₁-R₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In one embodiment, at least one (or some, or all) R group(s) of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. In another embodiment, at least one of R₅-R₉ and at least one of R₁₀-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In one embodiment, at least one of R₁-R₄ and at least one of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof. In another embodiment, at least one of R₁-R₄, at least one of R₅-R₉ and at least one of R₁₀-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a heteroatom, and combinations thereof.

In one embodiment, any consecutive R groups in R₁-R₄, and/or any consecutive R groups in R₅-R₉, and/or any consecutive R groups in R₁₀-R₁₄ may be linked to form an inter-cyclic or an intra-cyclic structure. The inter-/intra-cyclic structure may or may not be aromatic. In one embodiment, the inter-/intra-cyclic structure is a C₅ or a C₆ membered ring.

In one embodiment, at least one of R₁-R₄ is selected from a substituted hydrocarbyl group having 1 to 20 carbon atoms, an unsubstituted hydrocarbyl group having 1 to 20 carbon atoms, and combinations thereof. Optionally, at least one of R₅-R₁₄ may be a halogen atom or an alkoxy group having 1 to 20 carbon atoms. Optionally, R₁-R₄, and/or R₅-R⁹, and/or R₁₀-R₁₄ may be linked to form an inter-cyclic structure or an intra-cyclic structure. The inter-cyclic structure and/or the intra-cyclic structure may or may not be aromatic.

In one embodiment, any consecutive R groups in R₁-R₄, and/or in R₅-R₉, and/or in R₁₀-R₁₄, may be members of a C₅-C₆-membered ring.

In one embodiment, structure (I) includes R₁, R₃ and R₄ as hydrogen. R₂ is selected from a substituted hydrocarbyl group having 1 to 20 carbon atoms, an unsubstituted hydrocarbyl group having 1 to 20 carbon atoms, and combinations thereof. R₅-R₁₄ are the same or different and each of R₅-R₁₄ is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In one embodiment, R₂ is selected from a C₁-C₈ alkyl group, a C₃-C₆ cycloalkyl, or a substituted C₃-C₆ cycloalkyl group. R₂ can be a methyl group, an ethyl group, a n-propyl group, an isopropyl group, a t-butyl group, an isobutyl group, a sec-butyl group, a 2,4,4-trimethylpentan-2-yl group, a cyclopentyl group, and a cyclohexyl group.

In one embodiment, structure (I) includes R₂ that is methyl, and each of R₅-R₁₄ is hydrogen.

In one embodiment, structure (I) includes R₂ that is ethyl, and each of R₅-R₁₄ is hydrogen.

In one embodiment, structure (I) includes R₂ that is t-butyl, and each of R₅-R₁₄ is hydrogen.

In one embodiment, structure (I) includes R₂ that is ethoxycarbonyl, and each of R₅-R₁₄ is hydrogen.

In one embodiment, structure (I) includes R₂, R₃ and R₄ each as hydrogen and R₁ is selected from a substituted hydrocarbyl group having 1 to 20 carbon atoms, an unsubstituted hydrocarbyl group having 1 to 20 carbon atoms, and combinations thereof. R₅-R₁₄ are the same or different and each is selected from hydrogen, a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In one embodiment, structure (I) includes R₁ that is methyl, and each of R₅-R₁₄ is hydrogen.

In one embodiment, structure (I) includes R₂ and R₄ that are hydrogen and R₁ and R₃ are the same or different. Each of R₁ and R₃ is selected from a substituted hydrocarbyl group having 1 to 20 carbon atoms, an unsubstituted hydrocarbyl group having 1 to 20 carbon atoms, and combinations thereof. R₅-R₁₄ are the same or different and each of R₅-R₁₄ is selected from a substituted hydrocarbyl group having 1 to 20 carbon atoms, an unsubstituted hydrocarbyl group having 1 to 20 carbon atoms, an alkoxy group having 1 to 20 carbon atoms, a halogen, and combinations thereof.

In one embodiment, structure (I) includes R₁ and R₃ that are the same or different. Each of R₁ and R₃ is selected from a C₁-C₈ alkyl group, a C₃-C₆ cycloalkyl group, or a substituted C₃-C₆ cycloalkyl group. R₅-R₁₄ are the same or different and each of R₅-R₁₄ is selected from hydrogen, a C₁-C₈ alkyl group, and a halogen. Nonlimiting examples of suitable C₁-C₈ alkyl groups include methyl, ethyl, n-propyl, isopropyl, n-butyl, i-butyl, t-butyl, n-pentyl, i-pentyl, neopentyl, t-pentyl, n-hexyl, and 2,4,4-trimethylpentan-2-yl group. Nonlimiting examples of suitable C₃-C₆ cycloalkyl groups include cyclopentyl and cyclohexyl groups. In a further embodiment, at least one of R₅-R₁₄ is a C₁-C₈ alkyl group or a halogen.

In one embodiment, structure (I) includes R₁ that is a methyl group and R₃ that is a t-butyl group. Each of R₂, R₄ and R₅-R₁₄ is hydrogen.

In one embodiment, structure (I) includes R₁ and R₃ that is an isopropyl group. Each of R₂, R₄ and R₅-R₁₄ is hydrogen.

In one embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In one embodiment, structure (I) includes each of R₁, R₇, and R₁₂ as a methyl group and R₃ is a t-butyl group. Each of R₂, R₄, R₅, R₆, R₈, R_{9,} R₁₀, R₁₁, R₁₃, and R₁₄ is hydrogen.

In one embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In one embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In one embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In one embodiment, the substituted phenylene aromatic diester has a structure as illustrated below which includes R₁ that is a methyl group and R₃ is a t-butyl group. Each of R₂ and R₄ is hydrogen. R₈ and R₉ are members of a C₆ membered ring to form a 1-naphthoyl moiety. R₁₃ and R₁₄ are members of a C₆ membered ring to form another 1-naphthoyl moiety.

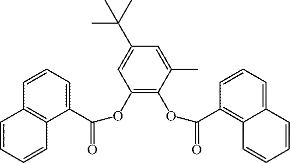 [SMILES: Cc1cc(C(C)(C)C)cc(OC(=O)c2cccc3ccccc23)c1OC(=O)c1cccc2ccccc12]

In one embodiment, the substituted phenylene aromatic diester has a structure as illustrated below which includes R₁ that is a methyl group and R₃ is a t-butyl group. Each of R₂ and R₄ is hydrogen. R₆ and R₇ are members of a C₆ membered ring to form a 2-naphthoyl moiety. R₁₂ and R₁₃ are members of a C₆ membered ring to form a 2-naphthoyl moiety.

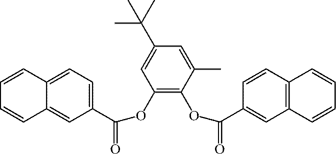 [SMILES: Cc1cc(C(C)(C)C)cc(OC(=O)c2ccc3ccccc3c2)c1OC(=O)c1ccc2ccccc2c1]

In one embodiment, structure (I) includes R₁ that is a methyl group and R₃ is a t-butyl group. Each of R₇ and R₁₂ is an ethoxy group. Each of R₂, R₄, R₅, R₆, R₈, R₉, R_{10,} R_{11,} R_{13,} and R₁₄ is hydrogen.

In one embodiment, structure (I) includes R₁ that is a methyl group and R₃ is a t-butyl group. Each of R₇ and R₁₂ is a fluorine atom. Each of R₂, R₄, R₅, R₆, R₈, R₉, R_{10,} R_{11,} R_{13,} and R₁₄ is hydrogen.

In one embodiment, structure (I) includes R₁ that is a methyl group and R₃ is a t-butyl group. Each of R₇ and R₁₂ is a chlorine atom. Each of R₂, R_{4,} R_{5,} R_{6,} R₈, R_{9,} R_{10,} R_{11,} R_{13,} and R₁₄ is hydrogen.

In one embodiment, structure (I) includes R₁ that is a methyl group and R₃ is a t-butyl group. Each of R₇ and R₁₂ is a bromine atom. Each of R₂, R_{4,} R_{5,} R_{6,} R_{8,} R_{9,} R_{10,} R_{11,} R_{13,} and R₁₄ is hydrogen.

In one embodiment, structure (I) includes R₁ that is a methyl group and R₃ is a t-butyl group. Each of R₇ and R₁₂ is an iodine atom. Each of R₂, R_{4,} R_{5,} R_{6,} Rs, R_{9,} R_{10,} R_{11,} R_{13,} and R₁₄ is hydrogen.

In one embodiment, structure (I) includes R₁ that is a methyl group and R₃ is a t-butyl group. Each of R_{6,} R_{7,} R_{11,} and R₁₂ is a chlorine atom. Each of R_{2,} R_{4,} R_{5,} R₈, R_{9,} R_{10,} R_{13,} and R₁₄ is hydrogen.

In one embodiment, structure (I) includes R₁ that is a methyl group and R₃ is a t-butyl group. Each of R_{6,} R_{8,} R_{11,} and R₁₃ is a chlorine atom. Each of R_{2,} R_{4,} R_{5,} R_{7,} R_{9,} R_{10,} R_{12,} and R₁₄ is hydrogen.

In one embodiment, structure (I) includes R₁ that is a methyl group and R₃ is a t-butyl group. Each of R₂, R₄ and R₅-R₁₄ is a fluorine atom.

In one embodiment, structure (I) includes R₁ that is a methyl group and R₃ is a t-butyl group. Each of R₇ and R₁₂ is a trifluoromethyl group. Each of R₂, R_{4,} R_{5,} R_{6,} R₈, R_{9,} R_{10,} R_{11,} R_{13,} and R₁₄ is hydrogen.

In one embodiment, structure (I) includes R₁ that is a methyl group and R₃ is a t-butyl group. Each of R₇ and R₁₂ is an ethoxycarbonyl group. Each of R_{2,} R_{4,} R₅, R_{6,} R₈, R_{9,} R_{10,} R_{11,} R₁₃ and R₁₄ is hydrogen.

In one embodiment, R₁ is a methyl group and R₃ is a t-butyl group. Each of R₇ and R₁₂ is an ethoxy group. Each of R₂, R_{4,} R₅, R_{6,} R₈, R_{9,} R_{10,} R_{11,} R_{13,} and R₁₄ is hydrogen.

In one embodiment, structure (I) includes R₁ that is a methyl group and R₃ is a t-butyl group. Each of R₇ and R₁₂ is a diethylamino group. Each of R₂, R_{4,} R₅, R_{6,} R₈, R_{9,} R_{10,} R_{11,} R_{13,} and R₁₄ is hydrogen.

In one embodiment, structure (I) includes R₁ that is a methyl group and R₃ is a 2,4,4-trimethylpentan-2-yl group. Each of R₂, R₄ and R₅-R₁₄ is hydrogen.

In one embodiment, structure (I) includes R₁ and R₃, each of which is a sec-butyl group. Each of R₂, R₄ and R₅-R₁₄ is hydrogen.

In one embodiment, the substituted phenylene aromatic diester has a structure as illustrated below whereby R₁ and R₂ are members of a C₆ membered ring to form a 1,2-naphthalene moiety. Each of R₅-R₁₄ is hydrogen.

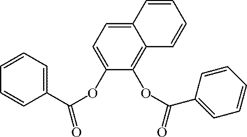 [SMILES: O=C(Oc1ccc2ccccc2c1OC(=O)c1ccccc1)c1ccccc1]

In one embodiment, the substituted phenylene aromatic diester has a structure as illustrated below whereby R₂ and R₃ are members of a C₆ membered ring to form a 2,3-naphthalene moiety. Each of R₅-R₁₄ is hydrogen.

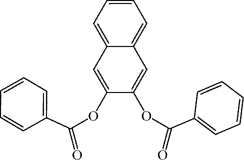 [SMILES: O=C(Oc1cc2ccccc2cc1OC(=O)c1ccccc1)c1ccccc1]

In one embodiment, structure (I) includes R₁ and R₄ that are each a methyl group. Each of R₂, R₃, R₅-R₉ and R₁₀₋R₁₄ is hydrogen.

In one embodiment, structure (I) includes R₁ that is a methyl group. R₄ is an i-propyl group. Each of R_{2,} R₃, R₅-R₉ and R₁₀₋R₁₄ is hydrogen.

In one embodiment, structure (I) includes R_{1,} R₃, and R_{4,} each of which is an i-propyl group. Each of R_{2,} R₅₋R₉ and R₁₀₋R₁₄ is hydrogen.

In one embodiment, each of R₁ and R₄ is selected from a methyl group, an ethyl group, and a vinyl group. Each of R₂ and R₃ is selected from hydrogen, a secondary alkyl group, or a tertiary alkyl group, with R₂ and R₃ not concurrently being hydrogen. Stated differently, when R2 is hydrogen, R3 is not hydrogen (and vice versa).

In one embodiment, a second internal electron donor may be used that generally comprises a polyether that can coordinate in bidentate fashion. In one embodiment the second internal electron donor is a substituted 1,3-diether of the structure below:

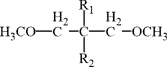

where R₁ and R₂ are the same or different, methyl, C₂-C₁₈ linear or branched alkyls, C₃-C₁₈ cycloalkyl, C₄-C₁₈ cycloalkyl-alkyl, C₄-C₁₈ alkyl-cycloalkyl, phenyl, organosilicon, C₇-C₁₈ arylalkyl, or C₇-C₁₈ alkylaryl radicals; and R₁ or R₂ may also be a hydrogen atom.

In one embodiment the second internal electron donor may comprise a 1,3-diether with cyclic or polycyclic having the following structure:

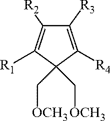

where R_{1,} R_{2,} R₃, and R₄ are as described for R₁ and R₂ of the diether structure or may be combined to form one or more C₅-C₇ fused aromatic or non-aromatic ring structures, optionally containing an N,O, or S heteroatom. Particular examples of the second internal electron donor include 4,4-bis(methoxymethyl)-2,6-dimethyl heptane, 9,9-bis(methoxymethyl)fluorene, or mixtures thereof.

The precursor is converted to a solid procatalyst by further reaction (halogenation) with an inorganic halide compound, preferably a titanium halide compound, and incorporation of the internal electron donors.

One suitable method for halogenation of the precursor is by reacting the precursor at an elevated temperature with a tetravalent titanium halide, optionally in the presence of a hydrocarbon or halohydrocarbon diluent. The preferred tetravalent titanium halide is titanium tetrachloride.

The resulting procatalyst composition can generally contain titanium in an amount from about 0.5% to about 6% by weight, such as from about 1.5% to about 5% by weight, such as from about 2% to about 4% by weight. The solid catalyst can contain magnesium generally in an amount greater than about 5% by weight, such as in an amount greater than about 8% by weight, such as in an amount greater than about 10% by weight, such as in an amount greater than about 12% by weight, such as in an amount greater than about 14% by weight, such as in an amount greater than about 16% by weight. Magnesium is contained in the catalyst in an amount less than about 25% by weight, such as in an amount less than about 23% by weight, such as in an amount less than about 20% by weight. The internal electron donor can be present in the catalyst composition in an amount less than about 30% by weight, such as in an amount less than about 25% by weight, such as in an amount less than about 22% by weight, such as in an amount less than about 20% by weight, such as in an amount less than about 19% by weight. The internal electron donor is generally present in an amount greater than about 5% by weight, such as in an amount greater than about 9% by weight.

In one embodiment, the procatalyst composition is combined with a cocatalyst to form a catalyst system. A catalyst system is a system that forms an olefin-based polymer when contacted with an olefin under polymerization conditions. The catalyst system may optionally include an external electron donor, an activity limiting agent, and/or various other components.

As used herein, a “cocatalyst” is a substance capable of converting the procatalyst to an active polymerization catalyst. The cocatalyst may include hydrides, alkyls, or aryls of aluminum, lithium, zinc, tin, cadmium, beryllium, magnesium, and combinations thereof. In one embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5- dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In one embodiment, preferred cocatalysts are selected from triethylaluminum, triisobutylaluminum, tri-n-hexylaluminum, diisobutylaluminum hydride, and di-n-hexylaluminum hydride, and most preferred cocatalyst is triethylaluminum.

In one embodiment, the cocatalyst is a hydrocarbyl aluminum compound represented by the formula RₙAlX₃₋ₙ wherein n = 1 or 2, R is an alkyl, and X is a halide or alkoxide. Nonlimiting examples of suitable compounds are as follows: methylaluminoxane, isobutylaluminoxane, diethylaluminum ethoxide, diisobutylaluminum chloride, tetraethyldialuminoxane, tetraisobutyldialuminoxane, diethylaluminum chloride, ethylaluminum dichloride, methylaluminum dichloride, and dimethylaluminum chloride.

In one embodiment, the catalyst composition includes an external electron donor. As used herein, an “external electron donor” is a compound added independent of procatalyst formation and contains at least one functional group that is capable of donating a pair of electrons to a metal atom. Bounded by no particular theory, it is believed that the external electron donor enhances catalyst stereoselectivity, (i.e., to reduces xylene soluble material in the formant polymer).

In one embodiment, the external electron donor may be selected from one or more of the following: an alkoxysilane, an amine, an ether, a carboxylate, a ketone, an amide, a carbamate, a phosphine, a phosphate, a phosphite, a sulfonate, a sulfone, and/or a sulfoxide.

In one embodiment, the external electron donor is an alkoxysilane. The alkoxysilane has the general formula: SiRₘ(OR’)₄₋ₘ (I) where R independently each occurrence is hydrogen or a hydrocarbyl or an amino group optionally substituted with one or more substituents containing one or more Group 14, 15, 16, or 17 heteroatoms, said R′ containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. Nonlimiting examples of suitable silane compositions include dicyclopentyldimethoxysilane, di-tert-butyldimethoxysilane, methylcyclohexyldimethoxysilane, methylcyclohexyldiethoxysilane, ethylcyclohexyldimethoxysilane, diphenyldimethoxysilane, diisopropyldimethoxysilane, di-n-propyldimethoxysilane, diisobutyldimethoxysilane, diisobutyldiethoxysilane, isobutylisopropyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, diethylaminotriethoxysilane, cyclopentylpyrrolidinodimethoxysilane, bis(pyrrolidino)dimethoxysilane, bis(perhydroisoquinolino)dimethoxysilane, and dimethyldimethoxysilane. In one embodiment, the silane composition is dicyclopentyldimethoxysilane (DCPDMS), methylcyclohexyldimethoxysilane (MChDMS), diisopropyldimethoxysilane (DIPDMS), n-propyltrimethoxysilane (NPTMS), diethylaminotriethoxysilane (DATES), or n-propyltriethoxysilane (PTES), and any combination of thereof.

In one embodiment, the external donor can be a mixture of at least 2 alkoxysilanes. In a further embodiment, the mixture can be dicyclopentyldimethoxysilane and methylcyclohexyldimethoxysilane, dicyclopentyldimethoxysilane and tetraethoxysilane, or dicyclopentyldimethoxysilane and n-propyltriethoxysilane.

In one embodiment, the external electron donor is selected from one or more of the following: a benzoate, and/or a diol ester. In another embodiment, the external electron donor is 2,2,6,6-tetramethylpiperidine. In still another embodiment, the external electron donor is a diether.

In one embodiment, the catalyst composition includes an activity limiting agent (ALA). As used herein, an “activity limiting agent” (“ALA”) is a material that reduces catalyst activity at elevated temperature (i.e., temperature greater than about 85° C.). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester, a diether, a poly(alkene glycol), poly(alkene glycol)ester, a diol ester, and combinations thereof. The carboxylic acid ester can be an aliphatic or aromatic, mono-or poly-carboxylic acid ester. Nonlimiting examples of suitable monocarboxylic acid esters include ethyl and methyl benzoate, ethyl p-methoxybenzoate, methyl p-ethoxybenzoate, ethyl p-ethoxybenzoate, ethyl acrylate, methyl methacrylate, ethyl acetate, ethyl p-chlorobenzoate, hexyl p-aminobenzoate, isopropyl naphthenate, n-amyl toluate, ethyl cyclohexanoate and propyl pivalate.

In one embodiment, the external electron donor and/or activity limiting agent can be added into the reactor separately. In another embodiment, the external electron donor and the activity limiting agent can be mixed together in advance and then added into the reactor as a mixture. In the mixture, more than one external electron donor or more than one activity limiting agent can be used. In one embodiment, the mixture is dicyclopentyldimethoxysilane and isopropyl myristate, dicyclopentyldiniethoxysilane and poly(ethylene glycol) laurate, dicyclopentyldimethoxysilane and isopropyl myristate and poly(ethylene glycol) dioleate, methylcyclohexyldimethoxysilane and isopropyl myristate, n-propyltrimethoxysilane and isopropyl myristate, dimethyldimethoxysilane and methylcyclohexyldimethoxysilane and isopropyl myristate, dicyclopentyldimethoxysilane and n-propyltriethoxysilane and isopropyl myristate, and dicyclopentyldimethoxysilane and tetraethoxysilane, isopropyl myristate, pentyl valerate and combinations thereof.

In one embodiment, the catalyst composition includes any of the foregoing external electron donors in combination with any of the foregoing activity limiting agents.

The polymer composition of the present disclosure can be used to produce numerous products and articles. The polymer composition, for instance, can be used to extrude various different articles, such as piping structures.

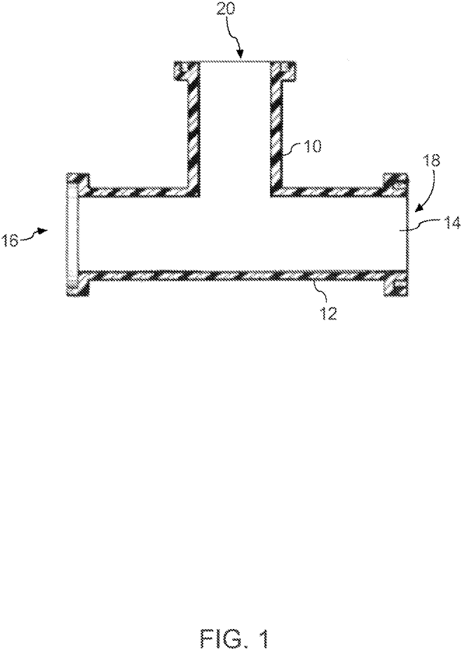

For example, referring to FIG. 1, one embodiment of a piping structure 10 that may be made in accordance with the present disclosure is shown. As illustrated, piping structure 10 includes a wall 12 made from the polymer composition of the present disclosure. The wall 12 defines a hollow interior passageway 14. In the embodiment illustrated in FIG. 1, the piping structure 10 includes a first opening 16 located opposite a second opening 18. In addition, the piping structure 10 includes an opening 20. The piping structure 10 illustrated in FIG. 1 has a “T” shape.

It should be understood, however, that various different piping structure may be made in accordance with the present disclosure including linear pipes, curved pipes such as elbows, fittings, and the like.

The present disclosure may be better understood with reference to the following example.

### EXAMPLE

The following example demonstrates some of the advantages and benefits of formulations made according the present disclosure.

A polypropylene and ethylene random copolymer was polymerized in a reactor using a non-phthalate catalyst as described above. The polymerization occurred using a single reactor to produce a monomodal polypropylene random copolymer. The ethylene propylene random copolymer has an MFR of 0.2 g/10 min, Et wt% of 4.48% and a XS % of 10%.

The above polypropylene polymer was combined with different antioxidants and additives. Eight different formulations were created. Sample No. 7 below was made in accordance with the present disclosure. Each formulation was tested for oxidation induction time according to ISO Test 11357-6 (2018). The following results were obtained:

TABLE 1

| Sample No. | OIT at 210° C. (min) | Antioxidant 1 | Antioxidant 2 | Antioxidant 3 | CaSt | Sodium Benzoate | Nucleating Agent | RST (ppm) |
|---|---|---|---|---|---|---|---|---|
| 1 | 30 | 3000 | 1500 | 3000 | 300 | | | |
| 2 | 33 | 3000 | 1500 | 3000 | | 900 | | |
| 3 | 40 | 3000 | 2000 | 3000 | | | | 500 |
| 4 | 39 | 3000 | 2000 | 3000 | | 900 | | |
| 5 | 36 | 3000 | 2000 | 3000 | | 900 | | 500 |
| 6 | 38 | 3000 | 2000 | 3000 | | 1200 | | |
| 7 | 48 | 3000 | 2000 | 3000 | 300 | | 500 | |
| 8 | 33 | 3000 | 2000 | 3000 | 300 | | | |

In the above Table:
Antioxidant 1: pentaerythrityl tetrakis (3,5-di-tert-butyl-4-hydroxyphenyl) propionate
Antioxidant 2: tris(2,4,di-tert-butylphenyl) phosphite
Antioxidant 3: 1,3,5-trimethyl-2,4,6-tris (3,5-di-tert-butyl-4-hydroxybenzyl) benzene
Nucleating Agent: calcium hexahydrophthalic acid
RST: commercially available stabilization package marketed by Baerlocher

As shown above, the sample made according to the present disclosure had a dramatically improved oxidation induction time.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

What is claimed:

1. A polymer composition well suited to forming piping structures, the polymer composition comprising:
a thermoplastic polymer combined with an oxidative stabilizer package, the oxidative stabilizer package comprising;
at least one sterically hindered phenolic antioxidant;
a phosphite antioxidant;
an acid scavenger; and
a nucleating agent, the nucleating agent comprising a phosphate ester, a dicarboxylate metal salt, or mixtures thereof; and
wherein the polymer composition displays an oxidation induction time when tested according to ISO Test 11357-6 (2018) at 210° C. of greater than 40 minutes.

2. The polymer composition of claim 1, wherein the polymer composition displays an oxidation induction time of greater than about 44 minutes.

3. The polymer composition of claim 1, wherein the nucleating agent comprises a metal salt of hexahydrophthalic acid.

4. The polymer composition of claim 3, wherein the nucleating agent comprises calcium hexahydrophthalic acid.

5. The polymer composition of claim 1, wherein the nucleating agent comprises a bicyclic dicarboxylate metal salt.

6. The polymer composition of claim 5, wherein the nucleating agent comprises disodium bicyclo[2.2.1]heptane-2,3-dicarboxylate.

7. The polymer composition of claim 1, wherein the nucleating agent comprises the phosphate ester.

8. The polymer composition of claim 7, wherein the phosphate ester has the following chemical structure: 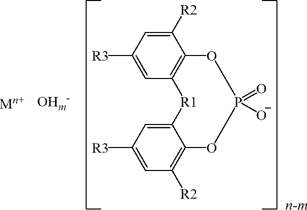
wherein:
R1 is oxygen, sulfur or a hydrocarbon group of 1 to 10 carbon atoms;
each of R2 and R3 is hydrogen or a hydrocarbon or a hydrocarbon group of 1 to 10 carbon atoms;
R2 and R3 may be the same or different from each other;
two of R2, two of R3, or R2 and R3 may be bonded together to form a ring;
M is a monovalent to trivalent metal atom; n is an integer from 1 to 3; and
m is either 0 or 1, provided that n>m.

9. (canceled)

10. The polymer composition of claim 1, wherein the nucleating agent comprises a mixture of a phosphate ester and a metal salt of hexahydrophthalic acid.

11. The polymer composition of claim 1, wherein each nucleating agent present in the composition is present in an amount from about 150 ppm to about 1500 ppm.

12. The polymer composition of claim 1, wherein the polymer composition contains a first sterically hindered phenolic antioxidant combined with a second sterically hindered phenolic antioxidant, the first sterically hindered phenolic antioxidant comprising pentaerythrityl tetrakis(3,5-di-tert-butyl-4-hydroxyphenyl) propionate, the second sterically hindered phenolic antioxidant comprising a benzyl compound.

13. (canceled)

14. The polymer composition of claim 1, wherein each sterically hindered phenolic antioxidant included in the composition is present in an amount of from about 500 ppm to about 9000 ppm.

15. The polymer composition of claim 1, wherein the phosphate antioxidant comprises tris(2,4,di-tert-butylphenyl) phosphite, the phosphite antioxidant being present in the polymer composition in an amount from about 250 ppm to about 5000 ppm.

16. The polymer composition of claim 1, wherein the acid scavenger comprises a metal salt of a fatty acid or a hydrotalcite.

17. (canceled)

18. The polymer composition of claim 16, wherein the acid scavenger is present in the composition in an amount from about 50 ppm to about 2000 ppm.

19. The polymer composition of claim 1, wherein the thermoplastic polymer comprises a polypropylene polymer.

20. The polymer composition of claim 1, wherein the thermoplastic polymer comprises a polypropylene random copolymer or a heterophasic polypropylene polymer.

21. The polymer composition of claim 1, wherein the thermoplastic polymer has a melt flow rate of from about 0.01 g/10 min to about 3 g/10 min.

22. The polymer composition of claim 1, wherein the thermoplastic polymer comprises a polypropylene polymer, the polypropylene polymer being present in the polymer composition in an amount greater than about 70% by weight.

23. The polymer composition of claim 1, wherein the thermoplastic polymer comprises a polypropylene polymer that has been Ziegler-Natta catalyzed, the polypropylene polymer being catalyzed in the presence of an internal electron donor comprising a non-phthalate, substituted phenylene aromatic diester.

24. A piping structure having a length and defining a first opening at one end and a second opening at an opposite end, the piping structure defining a hollow passageway therebetween, the piping structure being formed from the polymer composition of claim 1.

25. The piping structure of claim 24, wherein the piping structure has been formed through extrusion.
